(19) United States
(12) Patent Application Publication
(10) Pub. No.: US 2026/0100912 A1
(43) Pub. Date: Apr. 9, 2026

(54) EXTENDING FLOW CHANNELS ACROSS FABRICS

(71) Applicant: Hewlett Packard Enterprise Development LP, Spring, TX (US)

(72) Inventors: Jonathan P. Beecroft, Bristol (GB); Duncan Roweth, Bristol (GB)

(21) Appl. No.: 18/910,743

(22) Filed: Oct. 9, 2024

(51) Int. Cl. H04L 47/2441; H04L 47/27

(52) U.S. Cl. CPC H04L 47/2441; H04L 47/27

(57) ABSTRACT

One aspect of the instant application provides a system and method for extending a flow from a first network fabric into a second network fabric. During operation, the system may identify, at an egress edge node of the first network fabric, a flow to which a received packet belongs based on a first flow identifier associated with the packet. The egress edge node may forward the received packet to the second network fabric, where a respective node in the second network fabric may identify the flow based on a second flow identifier. The system may indicate to an upstream node of the forwarded packet exiting the first network fabric and keep the flow active within the first network fabric after all packets in the flow exit the first network fabric and until all packets arrive at a destination node.

### STATEMENT OF GOVERNMENT-FUNDED RESEARCH

This invention was made with Government support under Contract Number H98230-15-D-0022/0003 awarded by the Maryland Procurement Office. The Government has certain rights in this invention.

### BACKGROUND

### Field

This disclosure relates to implementing flow-based congestion control in networks. More specifically, this disclosure relates to extending the identification of flows (e.g., using connected flow channels) across multiple fabrics.

### Related Art

Various mechanisms have been developed in an attempt to manage congestion in computer networks. Some of these mechanisms are based around “flows,” where a flow may comprise a sequence of related packets that all have the same source and destination end points and may also have other similar properties such as belonging to the same traffic class, or being part of a single communication, for example, as in the case of a TCP flow. Separating packets into different flows of traffic and then managing the progress of those flows independently may significantly reduce the congestion within the whole system, because an individual flow unable to make good progress can be slowed down without the need to slow all the other flows at the same time. Therefore, the widespread congestion that would be caused by a single flow making poor progress in a system without the flow-separation capability does not occur when all the different flows of traffic are controlled individually. One mechanism that can operate at a link level and is able to separate all packets into separate individual flows is known as “Flow Channels”.

Flow channels serve as an essential mechanism in network traffic management. They can effectively segregate data packets destined for different endpoints while ensuring that packets bound for the same destination remain grouped and sequentially ordered. Moreover, the implementation of flow channels enables comprehensive monitoring of crucial network parameters. This includes tracking the precise path of packet flows, quantifying the volume of transmitted data, recording acknowledgments confirming successful packet delivery, and identifying instances of congestion throughout the network. By providing this detailed, real-time insight into network behavior, flow channels can significantly enhance the speed and efficacy of congestion control measures.

Current implementations of flow identification using flow channels are typically confined to a single switching fabric, where all devices operate under a unified set of management policies. Within this framework, a flow may be initiated at the fabric's ingress point, traverses a specific path through the fabric, and terminates at the egress point. However, such approaches present significant challenges in a multi-fabric network environment, where each fabric is potentially governed by distinct administrative domains and operational practices. This limitation hinders the ability to achieve seamless, end-to-end congestion management in more complex, multi-fabric network architectures, necessitating innovative solutions to extend the flow channels beyond the boundaries of a single switching fabric.

### BRIEF DESCRIPTION OF THE FIGURES

FIG. 1 illustrates an example network environment, according to one aspect of the instant application.

FIG. 2 illustrates the architecture of an example network node, according to one aspect of the instant application.

FIG. 3 presents a flowchart illustrating an example process for extending a flow channel from an upstream fabric to a downstream fabric, according to one aspect of the instant application.

FIG. 4 illustrates an example functional block diagram of a network device, according to one aspect of the instant application.

FIG. 5 illustrates a computer-readable medium that facilitates the separation of flows, according to one aspect of the instant application.

In the figures, like reference numerals refer to the same figure elements.

### DETAILED DESCRIPTION

According to some aspects of the instant application, data packets injected into a network may be categorized into distinct packet flows (or simply flows), based on a hash computed over their header fields including the destination, traffic class, and other fields as appropriate. A set of flow channels encompasses not only the physical path traversed by these flows but also the associated configuration information maintained by network devices, such as switches, along this route. Flow-based congestion control allows each node (e.g., a switch or router) along the data path to monitor and manage congestion levels for individual flows, thus enabling fast and effective congestion control and allowing the network to operate at a higher capacity.

Conventional implementations of flow channels are bounded within a single fabric, making it a challenge to apply flow-channel-based end-to-end congestion management, across multiple independently managed networks. This disclosure provides a mechanism to extend a flow channel (i.e., the ability to track a flow) across multiple independently managed fabrics. To keep a flow active, the flow extent (a parameter that tracks the total length of pending packets within a flow) is set to a non-zero small value at the egress port of a source fabric when the flow leaves the source fabric and enters a downstream fabric

In a fabric implementing flow-based congestion control, each flow channel may be marked by a distinctive identifier (e.g., the flow ID). For example, the ingress switch of a fabric may assign a flow ID to packets belonging to the same flow. This flow ID may be a locally significant value specific to a link, and this value may be unique only to a particular input port on a node. When the packets are forwarded to the next-hop node, the packets enter another link, and new flow ID may be selected for the next flow channel of the next link. More specifically, each link may have its own set of flow channels in each direction identified by their respective flow IDs. As the packets of a flow traverse multiple links and nodes, the flow IDs corresponding to this flow can form a unique chain of flow channels. At every node, the flow ID of an incoming packet may be used to map an entry in an input flow-channel table (IFCT), which stores state information for the corresponding flow. The outgoing packet may be updated to a flow ID used by the outgoing link, and the mapping between the incoming flow ID and the outgoing flow ID may be stored in an output flow-channel table (OFCT). This up-stream-to-down-stream one-to-one mapping between flow IDs may begin at the ingress edge node and end at the egress edge node. Because the flow IDs only need to be unique within an incoming link, a node may accommodate a large number of flows.

Flow channels may be set up and released dynamically, or “on the fly,” based on demand. Specifically, a flow channel is established (e.g., the flow ID to packet header mapping is established) at the ingress node when an initial packet of a flow arrives, and no flow ID has been previously assigned to the flow. As this initial packet travels through the network, flow IDs can be assigned at every node along the path traversed by the packet, and a chain of flow IDs (i.e., the sequentially connected flow channels) is established from the ingress node to the egress node. Subsequent packets belonging to the same flow use the same chains of flow IDs along the data path. When a packet is delivered to the destination egress node, the egress node may generate and send an acknowledgment (ACK) packet in the upstream direction along the same data path to the ingress node. The ACK packet may indicate the amount of acknowledged data. After receiving the ACK packet, each node along the data path may update its state information with respect to the amount of outstanding, unacknowledged data for this flow. More specifically, the amount of transmitted but unacknowledged data may be indicated by a variable referred to as “flow extent.” At each node, the flow-extent value may increment for each transmitted packet and decrement for each received ACK packet. When the flow extent at a node' reaches zero, meaning that there is no more unacknowledged data, the node may release the flow ID (i.e., release this segment of flow channel) and re-use the flow ID or channel for other flows. As the ACK for the last packet in a flow traverses the network, it may reduce the flow-extent value to zero at each node, thus releasing the corresponding flow channel segment along the data path in the reverse order. When the ACK for the last packet in the flow reaches the ingress node, the entire flow is released or torn down.

In conventional approaches, flow channels are implemented within a single fabric, and flow IDs may be mapped to the packets' fabric destination addresses. When a packet is received, address translation is performed to convert an external Media Access Control (MAC) or Internet Protocol (IP) address in the packet header to the internal fabric address. In situations where multiple independently managed systems are deployed at a single site (e.g., a supercomputer system and a storage system at a weather forecasting site), each system may have its own fabric and header translation requirement, meaning that the ingress node in the ingress fabric does not have knowledge of the fabric address of the egress node in the egress fabric. To extend the flow channels across the multiple fabrics, according to some aspects of the instant application, packets may be separated into different flow channels based on a single large hash value, which is computed using a plurality of header fields in the packet without header translation. The header fields may include but are not limited to: the Internet protocol (IP) address fields (e.g., source/destination address), the User Datagram Protocol (UDP) port fields (e.g., source/destination port), the traffic-class field, the Differentiated Services Code Point (DSCP) field, the flow-label field, the Virtual Network Identifier (VNI) field, the job identifier field, the UEC entropy fields, the snoop-number field, etc. Additional examples of the header fields may include the Ethernet layer 2 (L2) header, the Internet protocol (IP) version 4 (IPv4) or IPv6 layer 3 (L3) header, and/or a layer 4 (L4) header, such as a Transmission Control Protocol (TCP) or a User Datagram Protocol (UDP) header. If the packet has been encapsulated for network overlays or other purposes, then the L2, L3, and/or L4 headers of the encapsulated packet may also be included. Any of the fields that are extracted by the packet parser, taken from multiple headers of the layered protocols, may be included in the hash computation. Additional header information, including but not limited to the source port and other meta data that might be included in a subsequent translation lookup, may also help generating the hash value. Entropy values taken from local storage (e.g., the control and status registers) may also be included.

In some aspects, the hash value is computed based on all header fields of an incoming packet to ensure a sufficiently large entropy such that the flow separation will be sufficient, no matter how may fabrics the flow traverses. However, packet header fields that might change for a given flow (e.g., Explicit Congestion Notification (ECN) field used to indicate congestion or packet sequence number) should preferably not be included in the hash computation, as they may cause packets belonging to a single flow to be separated into multiple flows. Splitting a flow into multiple flows may lead to packets being out of order, which usually is undesirable.

Extending a flow identification across multiple fabrics allows end-to-end congestion management where congestion detected in a downstream fabric may be reported to nodes in the upstream fabric. In some examples, the endpoint or mid-fabric congestion in the downstream fabric may be taken into account when injecting packets into the upstream fabric. In addition, there is a need to decouple the fabrics such that data load in the downstream fabric do not affect the upstream fabric and vice versa. Because the fabrics are independently managed and may have different injection limits (i.e., the amount of data that may be injected into a fabric at its ingress), it is desirable to ensure that the load in the downstream fabric does not significantly affect the injection of traffic into the upstream fabric. The injection limit can prevent more data from being injected than is necessary to sustain the desired bandwidth.

In situations where nodes in the upstream fabric may not receive an acknowledgment for the packet due to errors in the downstream fabric, even if it has exited the fabric, a time-out mechanism may be used to terminate the flow after no ACK is received after a predetermine interval.

One approach to decouple the upstream and downstream fabrics is to configure the egress node of the upstream fabric to immediately acknowledge packets as they exit the fabric. However, sending the ACK packets upstream would decrement the flow-extent value on each node along the data path, and when the flow-extent value is reduced to zero on the egress node in the upstream fabric, the flow channel is released, even if packets belonging to the same flow are still propagating in the downstream fabric. If the flow channel is no longer active, congestion information associated with the flow in the downstream fabric would not be reported to nodes in the upstream fabric, making it impossible to implement end-to-end congestion management.

To keep the flow channel active in the upstream fabric, according to some aspects of the instant application, the egress node of the upstream fabric may be configured to acknowledge packets as they exit the fabric but set the flow-extent value to a non-zero small value. In one example, when the initial packet of a flow exits the egress node, instead of generating and sending an ACK to acknowledge all data in this initial packet, the egress node may generate and send an ACK that acknowledges all but a small portion of data. In other words, the edge node may withhold acknowledgment to a small portion of data in the initial packet, even after such data has been transmitted to the downstream fabric. The egress node may acknowledge subsequent packets in the flow normally. The unacknowledged data in the initial packet may result in the flow-extent value on each node along the data path not being reduced to zero, thus keeping the flow open. Such a small portion of data will only be acknowledged after all packets in the flow reach their final destination egress node, and the flow channel will be released at that time. In some examples, the flow extent and the amount of data acknowledged by the ACK packets may be measured in a number of fixed-length data units. In one example, a data unit (also referred to as a flow unit) may include 256 bytes. In a further example, the flow-extent value of a flow on the egress node of the upstream fabric may be set to one data/flow unit after all packets in the flow exit the fabric.

Setting the flow extent to a small non-zero value (e.g., one flow unit) at the boundary of the fabrics not only ensures that the flow channel remains active before all packets reach their final destination but also decouples the fabrics, such that data load in the downstream fabric do not affect the upstream fabric and vice versa. Moreover, because the flow channel remains open when the packets are propagating in the downstream fabric, the congestion state about the flow channel may be updated by other ACK packets (e.g., congestion ACKs), thus facilitating end-to-end flow control.

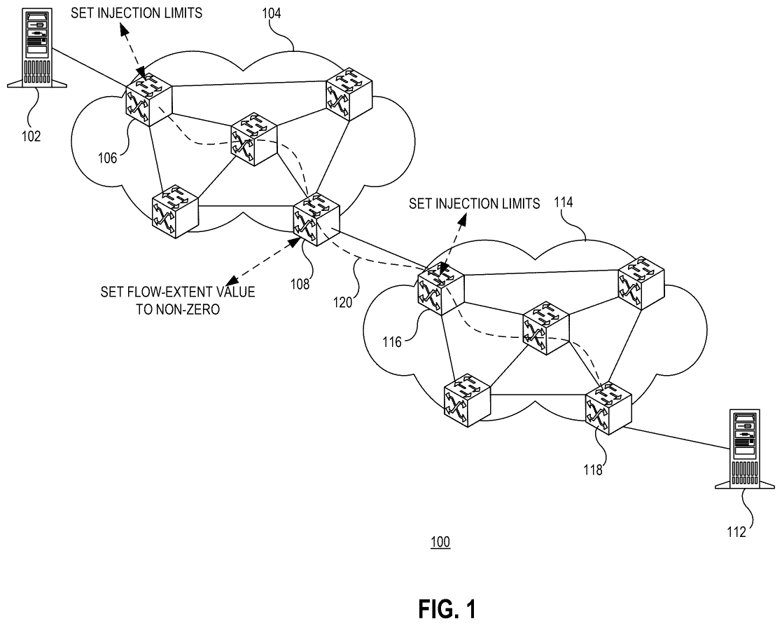

FIG. 1 illustrates an example network environment, according to one aspect of the instant application. In FIG. 1, a network environment 100 may include two independently managed systems. The first system may include a server 102 and a switch fabric 104, and the second system may include a server 112 and a switch fabric 114. Each switch fabric may include a plurality of interconnected switches. For example, switch fabric 104 includes switches 106 and 108, and switch fabric 114 includes switches 116 and 118.

FIG. 1 also shows the path of a flow 120 established between the ingress port that server 102 is connected to and the egress port that server112 is connected to, indicated by a dashed line. As discussed previously, when the initial packet belonging to flow 120 is injected into ingress switch 106 of fabric 104, ingress switch 106 may assign a flow ID (i.e., allocate a new flow channel) to the packet, the flow ID being unique to the input port receiving the packet. To ensure that the flow channel may be extended from fabric 104 into fabric 114, the flow ID may be mapped to a large hash value generated based on a plurality of untranslated header fields of the injected packet. By computing the large hash value and mapping it to a locally unique flow ID, packets belonging to different flows may be separated into different flow channels at the ingress.

The ingress node maintains an edge flow-channel table (EFCT) that stores the mapping between the large hash value and the flow ID. In addition, each node maintains an IFCT that stores state information associated with each flow, such as the flow extent. An entry in an IFCT corresponding to a flow may also include a flow-specific injection limit, which can control the amount of data injected into the fabric by the flow. In order to facilitate flow-based congestion control, the injection limit may be compared with the flow-extent value in the IFCT of each node passed by the flow. If the flow-extent value is greater than the injection limit at one node (e.g., more data has been injected than allowed), the node may stop forwarding packets belonging to the flow. In addition to the per-flow injection limit, the ingress node may maintain a per-traffic-class injection limit, which limits the amount of data to be injected into the fabric by all flows in a given traffic class. In such a case, the sum of the flow-extent values for all active flows in the traffic class is compared against the traffic-class-specific injection limit. If the sum of the flow-extent values for a particular traffic class is greater than the corresponding injection limit, the injection of packets belonging to the traffic class into the fabric may be paused.

According to some aspects, injection limits (e.g., the per-flow or per-traffic-class limits) may be set independently at the ingress node of each fabric. For example, the injection limits may be set at ingress node 106 of fabric 104 and at ingress node 116 of fabric 114. If an ingress node includes multiple ingress ports, the injection limit may be set on a per-ingress-port basis. More specifically, the system may measure the amount of data that has been injected into the fabric on a per-ingress-port basis and set the injection limits to impose a cap on the total amount of data a port can inject into the fabric.

At egress node 108 of upstream fabric 104, the flow extent of a flow may be set to a non-zero small value (e.g., one flow unit) by immediately acknowledging all but a small portion of data exiting fabric 104. In some examples, all packets but the initial one in a flow may be immediately acknowledged in their entirety when they exit egress node 108, thus decrementing the flow-extent values in the upstream nodes. In one example, the initial packet of the flow may include 10 flow units (e.g., 2560 bytes). Responsive to receiving the initial packet, egress node 108 may generate and send back an ACK packet that acknowledges 9 flow units, leaving one flow unit of data in the initial packet unacknowledged. As the ACK packets traverse the reverse data path toward ingress node 106, the flow-extent value on each node may be set to at least one flow unit, ensuring that flow 120 remains active in fabric 104. Note that the flow-extent value may be reset to its normal value (which indicates the amount of transmitted and unacknowledged data in the downstream fabric 114) at the egress port of egress node 108. At ingress node 116 of fabric 114, the flow-extent value for the flow is the normal value and may be compared with the injection limit at ingress node 116 to determine whether to forward packets in the flow.

At the destination egress node (i.e., egress node 118 of downstream fabric 114), responsive to receiving all packets in the flow, a flow-terminating ACK packet may be generated and sent back upstream. Upon receiving the flow-terminating ACK packet, egress node 108 of the upstream fabric 104 may generate and send back an ACK packet for the small portion of unacknowledged data toward ingress node 106 to terminate flow 120 in fabric 104.

According to alternative aspects, other mechanisms may be used to keep the flow open in the upstream fabric. In some examples, the ACK packets generated and returned by the destination edge node may include a keep-channel-open flag field to indicate to all upstream nodes that the flow channel should be kept open. The keep-channel-open flag field in the last ACK packet for a flow may be reset to indicate that the flow channel may be released.

The example shown in FIG. 1 includes two coupled fabrics. In practice, the same solution (including timely acknowledging data packets as they exit a fabric and keeping the flow open until all packets reach their final destination) may be extended to more than two fabrics (e.g., three or more coupled fabrics). In one example, the egress edge node of each fabric may be configured to acknowledge all but a small portion of transmitted data to keep the flow channel active. In another example, the egress edge node of each fabric may generate and send ACK packets with a keep-channel-open flag field to notify upstream nodes to keep the flow channel active.

Each node in FIG. 1 is a computing device, which may be any single computing device, a set of computing devices, a portion of one or more computing devices, or any other physical, virtual, and/or logical grouping of computing resources. According to some aspects, a computing device is any device, portion of a device, or any set of devices capable of electronically processing instructions and may include, but is not limited to, any of the following: one or more processors (e.g., components that include circuitry) (not shown), memory (e.g., random access memory (RAM)) (not shown), input and output device(s) (not shown), non-volatile storage hardware (e.g., solid-state drives (SSDs), persistent memory (Pmem) devices, hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smartphone, personal digital assistant, tablet computer, automobile computing system, and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, and/or any other type of computing device with the aforementioned requirements.

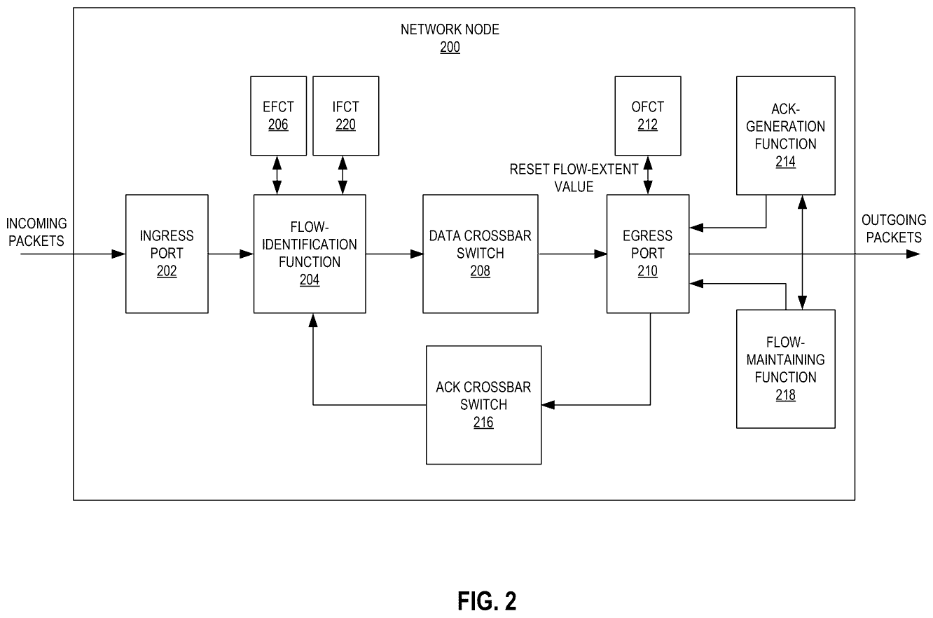

FIG. 2 illustrates the architecture of an example network node, according to one aspect of the instant application. In FIG. 2, a network node 200 may include an ingress port 202, a flow-identification function 204, an EFCT 206, a data crossbar switch 208, an egress port 210, an OFCT 212, an ACK-generation function 214, an ACK crossbar switch 216, a flow-maintaining function 218, and an IFCT 220. In some examples, network node 200 may be an egress edge switch of a switching fabric. The various components in network node 200 may be implemented using any form of hardware, software, or a combination thereof.

Ingress port 202 is responsible for receiving data packets from end hosts coupled to network node 200. Depending on the implemented communication protocol, the data packets may include various headers. In one example, the data packets may be Ethernet frames with Ethernet headers. In some examples, the data packets may include a fabric header comprising a flow ID. According to some aspects, the flow ID may be mapped to a hash value computed using a plurality of untranslated header fields in the packet. When a packet traverses multiple fabrics, the hash value may be computed based on header information associated with the multiple fabrics. Examples of plurality of header fields may include but are not limited to the IP address fields (e.g., source/destination address), the User Datagram Protocol (UDP) port fields (e.g., source/destination port), the traffic-class field, the DSCP field, the flow-label field, the VNI field, the job identifier field, the UEC entropy fields, the snoop-number field, etc. Additional examples of the header fields may include the L2 header, the IPv4 or IPv6 L3 header, and/or the L4 header, such as a TCP or UDP header. If the packet has been encapsulated for network overlays or other purposes, then the L2, L3, and/or L4 headers of the encapsulated packet may also be included. Any of the fields that are extracted by the packet parser, taken from multiple headers of the layered protocols, may be included in the hash computation. Additional header information, including but not limited to the source port and other meta data that might be included in a subsequent translation lookup, may also help generating the hash value. Entropy values taken from local storage (e.g., the control and status registers) may also be included.

Flow-identification function 204 is responsible for identifying a flow to which the received packet belongs based on the flow ID included in the fabric header. According to some aspects, flow-identification function 204 may perform a lookup operation in EFCT 206 based on the hash identify a matching entry with a previously allocated flow ID. In some aspects, EFCT 206 may be stored in a Ternary Content Addressable Memory (TCAM), such as a TCAM or any other hash-based lookup function suitable for exact match operations. It is also possible to implement any function capable of performing match operations (i.e., any match function), such as an exact match hash function implemented using multiple RAMs or a match function implemented using a plurality of discrete logic gates. If no matching entry is found in EFCT 206, the packet belongs to a new flow, and a new flow ID may be allocated for the flow at input port of network node 200. The flow ID can also be used to identify or allocate a flow-specific input queue (not shown in FIG. 2) in which the incoming packet can be temporarily stored. State information about the flow (e.g., the flow state, the blocking state, and the forwarding state) and congestion information may be stored in IFCT 220. IFCT 220 may also store parameters for monitoring and controlling the flow-specific input queues.

Data crossbar switch 212 is responsible for forwarding data packets from the flow-specific input queues to egress port 210. Egress port 210 is responsible for sending the outgoing packet to the next-hop node. Egress port 210 may perform a lookup in OFCT 212 using the flow ID included in the packet header. The lookup may return an outgoing flow ID, which may be used to update the flow ID in the packet header. OFCT 212 may store information that can be used to compute the flow-extent value for each active flow. For example, an entry in OFCT 212 may include a data_flow field that tracks the amount of transmitted data and an ACK_flow field that tracks the amount of acknowledged data. The flow-extent value may be computed based on the difference between the data_flow field and the ACK_flow field. In some examples, OFCT 212 may store the flow-extent value for each active flow.

ACK-generation function 214 is responsible for generating ACK packets corresponding to packets exiting the switch fabric. More specifically, an ACK packet may indicate to the upstream node of network node 200 that the corresponding packet is exiting the switch fabric, thus reducing the flow extent and allowing new packet data equivalent in size to the data represented in the ACK packet to pass the injection limit and be allowed into the fabric. In other words, when the per-flow injection limit is set at the ingress of the switch fabric, the exited packet is not considered part of the load in the switch fabric. Timely acknowledgment of the transmitted data packets may effectively decouple the load in the downstream fabric from the upstream fabric. The generated ACK packets may be forwarded upstream via ACK crossbar switch 216.

Network node 200 further includes a flow-maintaining function 218 configured to keep the flow channel active within the switch fabric after all packets in the flow channel exit the switch fabric and until all packets arrive at a destination node. According to some aspects, flow-maintaining function 218 may configure ACK-generation function 214 to acknowledge all but a small portion of transmitted data, thus preventing the flow-extent value from being reduced to zero after all packets in a flow exit the switch fabric. According to alternative aspects, after all packets in a flow exit the switch fabric, flow-maintaining function 218 may include logic that may directly reset the flow-extent value to a fixed small value (e.g., one or a few flow units) stored in OFCT 212. Maintaining the flow channel across the fabric boundary ensures that congestion (e.g., endpoint congestion and mid-fabric congestion) in the downstream fabric may be reported (via ACK packets) to nodes in the upstream fabric. Therefore, congestion in the downstream fabric would be taken into account when the injection limits are set at the ingress of the upstream fabric.

Moreover, extending the flow channel across multiple fabrics enables the congestion-management system to distinguish congestions on a link aggregation group (LAG) between the upstream and downstream fabrics from the endpoint or mid-fabric congestion in the downstream fabric. Extending the flow channel across multiple fabrics also allows a whole flow to be rerouted onto a different link, connecting these two fabric together, without the possibility of any of the packets being reordered within the flow. All packets of a flow are kept in their original order. More specifically, congestion in the downstream fabric is reported via ACK packets, which may be generated at the destination edge switch or intermediate switches, whereas congestion in the LAG may be reflected by the queue status. Congestion in the LAG may be mitigated via various load-balancing techniques. In some examples, ACK-generation function 214 may generate redirecting ACKs that may be used to redirect traffic among the different links in the LAG.

Other than setting the flow-extent value in OFCT 212 to a small value, according to some aspects, flow-maintaining function 218 may also set a keep-channel-open flag field in the ACK packets generated by ACK-generation function 214, indicating to all upstream nodes that the corresponding flow channel should be kept open.

Flow-maintaining function 218 is also responsible for deactivating the flow channel after all packets in the flow reach their final destination. For example, after determining that all packets in the flow have reached their final destination (e.g., after receiving an ACK from the destination edge switch for the last packet in the flow), flow-maintaining function 218 may configure ACK-generation function 214 to generate an ACK packet to acknowledge the previously unacknowledged small portion of data in the initial packet, thus reducing the flow-extent value in network node 200 to zero. In alternative examples, flow-maintaining function 218 may update the keep-channel-open flag field in the ACK packet to indicate to upstream nodes that the flow channel is ready to be released.

According to some aspects, network node 200 may also include a header-modification function (not shown in FIG. 2) responsible for adding, removing, or modifying the headers of the data packets. This ability allows the data packets to tunnel through a third-party fabric (e.g., by adding an encapsulation header or IP option field containing an identifier to be returned by the destination fabric) while implementing the end-to-end flow control. Moreover, congestion information detected in the third-party fabric may be parsed at the edge of the upstream fabric and used to update the state information of the flow.

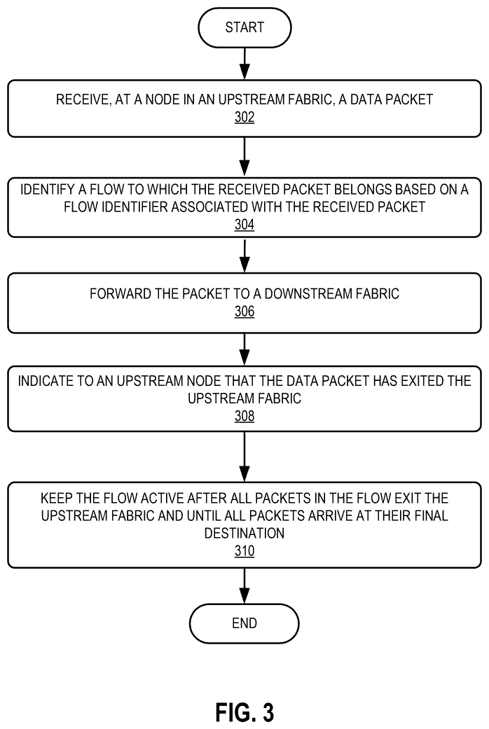

FIG. 3 presents a flowchart illustrating an example process for extending a flow channel from an upstream fabric to a downstream fabric, according to one aspect of the instant application. All or any portion of the operations shown in FIG. 3 may be performed, for example, by a device or set of devices (e.g., egress edge node 108 or network node 200 shown in FIG. 1 and FIG. 2, respectively). Although the example process in FIG. 3 shows a specific order of performing certain operations, the process is not limited to such an order. Operations shown in succession in the flowchart may be performed in a different order and may be executed concurrently or with partial concurrence or combinations thereof.

During operation, a node in an upstream fabric may receive a data packet (operation 302). The node may be an egress edge node (e.g., node 108 shown in FIG. 1) that couples an upstream fabric to a downstream fabric. Depending on the implemented communication protocol, the data packet may be a Transmission Control Protocol (TCP) packet, a UDP datagram, an IP packet, an Ethernet packet, etc.

A flow-identification logic unit implemented on the node may identify a flow channel to which the received packet belongs based on a first flow identifier associated with the received packet (operation 304). The flow-identification logic unit may be similar to flow-identification function 204 shown in FIG. 2. The first flow ID may be included in a fabric header of the received packet. The first flow ID may be mapped at the ingress node of the fabric to a first hash value computed based on header information associated with the upstream fabric. The first flow ID allows the flow channel to be identified uniquely in the first fabric. Examples of packet header information may include but are not limited to the IP address information (e.g., the source/destination address), UDP port information (e.g., the source/destination port), traffic-class information, DSCP information, flow-label information, packet-encapsulation information (e.g., the VNI), UEC entropy information, snoop metadata (e.g., the snoop number), etc.

The egress port of the node may forward the packet to the downstream fabric (operation 306). In one example, the packet may be forwarded to the ingress node of the downstream fabric via a LAG. Nodes in the downstream fabric may identify the flow channel based on a second flow ID. The second flow ID may be mapped at the ingress node of the downstream fabric to a second hash value computed based on a plurality of headers associated with the downstream fabric. Examples of header fields may include but are not limited to a source address field, a destination address field, a traffic class field, an encapsulation header field, a Differentiated Service Code Point (DSCP) field, a User Datagram Protocol (UDP) port field, one or more Ultra Ethernet Consortium (UEC) Transport headers, or a snoop number field. The second flow ID allows the flow channel to be identified uniquely in the second fabric.

Subsequent to forwarding the packet to the downstream fabric, the egress node may indicate to an upstream node that the data packet has exited the upstream fabric (operation 308). According to some aspects, an ACK-generation logic unit implemented on the egress node may generate an ACK packet to acknowledge the transmission of the data packet. In some examples, the ACK packet may specify a number of flow units corresponding to the acknowledged data. Timely acknowledgment of the exiting data packet may prevent the packet from affecting the injection of packets into the flow channel at the ingress of the upstream fabric. More specifically, when setting the per-flow injection limit at the ingress node of the upstream fabric, the system does not include the exiting packet as part of the data load in the upstream fabric. The egress node may update the flow-extent value stored in its OFCT based on the ACK packet. The flow-extent value tracks pending (i.e., transmitted but not acknowledged) data in the flow channel within the first network fabric based on the ACK packet.

After all packets in the flow channel exit the upstream fabric, the egress node keeps the flow channel active until all packets arrive at their final destination (operation 310). According to some aspects, the ACK-generation logic unit may be configured to acknowledge all but a small portion of data (e.g., one or a few flow units) in the flow to prevent the flow extent from being reduced to zero. The non-zero flow-extent value ensures that the flow channel remains active. According to alternative aspects, the ACK-generation logic unit may be configured to generate ACK packets with a keep-channel-open flag field to notify the edge node and any upstream node receiving the ACK packets to keep the flow channel active.

Subsequent to all packets in the flow reaching the destination node (e.g., transmitted to the destination server by the destination edge switch in the downstream fabric), the destination edge switch may generate and return a flow-terminating ACK packet upstream. Upon receiving the flow-terminating ACK packet, the egress edge node in the upstream fabric may acknowledge the last small portion of data in the flow to release or terminate the flow channel in the upstream fabric. According to alternative aspects, the flow-terminating ACK packet may have its keep-channel-open flag field unset to notify upstream nodes to terminate the flow channel.

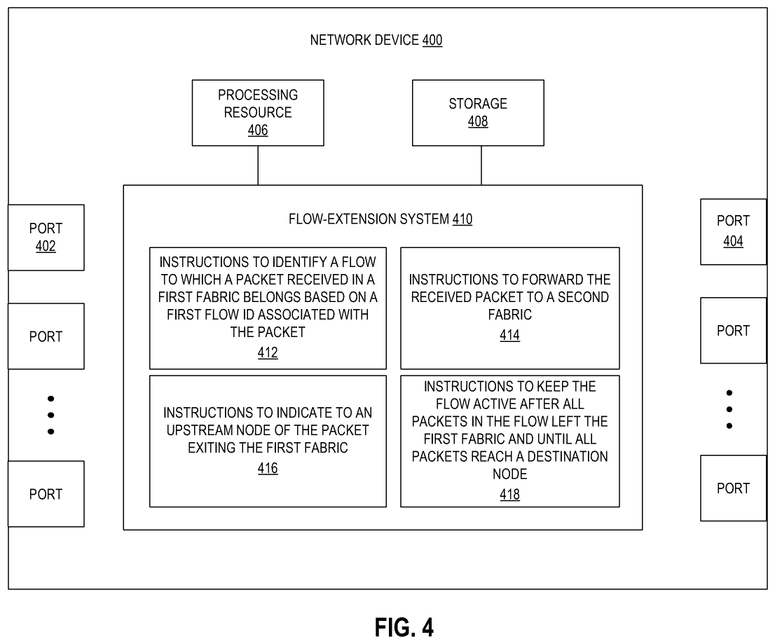

FIG. 4 illustrates an example functional block diagram of a network device, according to one aspect of the instant application. Network device 400 may include any physical devices that allow hardware on a computer network to communicate and interact with one another. Examples of network device 400 may include a switch, a router, a gateway, an access point, a network interface card (NIC), etc. In FIG. 4, network device 400 may include a number of communication ports, such as ports 402 and 404, for communicating with peer network devices. Each port may include a transmitter and a receiver.

Network device 400 may include one or more processing resources (e.g., processing resource 406), one or more storage devices (e.g., storage device 408), and a flow-extension system 410. Network device 400 may include fewer or more entities than those shown in FIG. 4.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Flow-extension system 410 may include any number of software units, hardware units, and firmware units that work together to achieve the goal of extending a flow channel across at least the first and second fabrics. According to some aspects, flow-extension system 410 may include instructions that when executed by processing resource 406 may cause processing resource 406 to perform methods and/or processes described in this disclosure. Specifically, flow-extension system 410 may include instructions 412 to identify a flow channel to which a packet received in a first fabric belongs based on a first flow ID associated with the received packet, as described above in relation to operation 304 shown in FIG. 3. According to some aspects, the first flow ID may be determined based on a hash value computed at the ingress of the first fabric. The hash value may be computed based on packet header information associated with the first network fabric, thus allowing the flow channel to be uniquely identified in the first network fabric. Examples of the packet header information may include but are not limited to the IP address information (e.g., the source/destination address), UDP port information (e.g., the source/destination port), traffic-class information, DSCP information, flow-label information, packet-encapsulation information (e.g., the VNI), the job identifier field, UEC entropy information, snoop metadata (e.g., the snoop number), etc. Additional examples of the header fields may include the L2 header, the IPv4 or IPv6 L3 header, and/or the L4 header, such as a TCP or UDP header. If the packet has been encapsulated for network overlays or other purposes, then the L2, L3, and/or L4 headers of the encapsulated packet may also be included. Any of the fields that are extracted by the packet parser, taken from multiple headers of the layered protocols, may be included in the hash computation. Additional header information, including but not limited to the source port and other meta data that might be included in a subsequent translation lookup, may also help generating the hash value. Entropy values taken from local storage (e.g., the control and status registers) may also be included.

Flow-extension system 410 may include instructions 414 to forward the received packet to a second fabric, as described above in relation to operation 306 shown in FIG. 3. According to some aspects, the packet may be forwarded to the ingress node of the downstream fabric via a LAG. A node in the second network fabric may identify the flow channel based on a second flow identifier, which may be mapped to a hash value computed at the ingress of the downstream fabric.

Flow-extension system 410 may include instructions 416 to indicate to an upstream node of the packet exiting the first fabric, as described above in relation to operation 308 shown in FIG. 3. According to some aspects, instructions 416 may be used to generate an ACK packet to acknowledge the transmission of the data packet. The ACK packet may specify a number of flow units corresponding to the acknowledged data. The egress node may update the flow-extent value stored in its OFCT based on the ACK packet.

Flow-extension system 410 may include instructions 418 to keep the flow channel active after all packets in the flow left the first fabric and until all packets reach a destination node, as described above in relation to operation 310 shown in FIG. 3. According to some aspects, instruction 418 may be used to generate ACK packets that acknowledge all but a small portion of data (e.g., one or a few flow units) in the flow to prevent the flow-extent from being reduced to zero. According to alternative aspects, instruction 418 may be used to generate ACK packets with a keep-channel-open flag field to notify the edge node and any upstream node receiving the ACK packets to keep the flow channel active.

Flow-extension system 410 may include more instructions than those shown in FIG. 4. For example, flow-extension system 410 may include instructions to terminate the flow channel responsive to receiving a flow-terminating ACK packet from the destination node. Flow-extension system 410 may also include instructions to independently set the injection limits at the ingress of the upstream and downstream fabrics. Flow-extension system 410 may further include instructions to perform flow-based congestion control. The instructions may be used to pause packet injection into the respective network fabric in response to a sum of flow-extent values of all active flow channels within the respective network fabric greater than the injection limit.

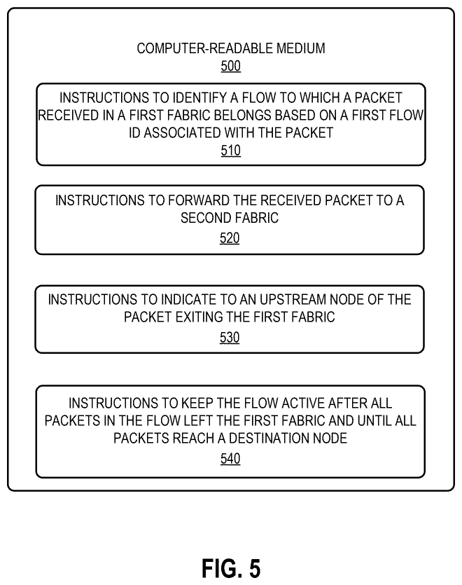

FIG. 5 illustrates a computer-readable medium that facilitates the separation of flows, according to one aspect of the instant application. CRM 500 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 500 may store instructions 510 to identify a flow channel to which a packet received in a first fabric belongs based on a first flow ID associated with the received packet, as described above in relation to operation 304 shown in FIG. 3; instructions 520 to forward the received packet to a second fabric, as described above in relation to operation 306 shown in FIG. 3; instructions 530 to indicate to an upstream node of the packet exiting the first fabric, as described above in relation to operation 308 shown in FIG. 3; and instructions 540 to keep the flow channel active after all packets in the flow left the first fabric and until all packets reach a destination node, as described above in relation to operation 310 shown in FIG. 3.

CRM 500 may include more instructions than those shown in FIG. 5. For example, CRM 500 may include instructions to terminate the flow channel responsive to receiving a flow-terminating ACK packet from the destination node. CRM 500 may also include instructions to independently set the injection limits at the ingress of the upstream and downstream fabrics. CRM 500 may further include instructions to perform flow-based congestion control. The instructions may be used to pause packet injection into the respective network fabric in response to a sum of flow-extent values of all active flow channels within the respective network fabric greater than the injection limit.

In general, aspects of the disclosure solve the technical problem of extending a flow(i.e., the ability to track a flow) across multiple independently managed fabrics. When a packet in a flow leaves the upstream fabric and enters a downstream fabric, the packet is immediately acknowledged at the egress node of the upstream fabric to ensure that data load in the downstream fabric does not affect the upstream fabric and vice versa. More specifically, the injection limits of the two fabrics may be set independently. Moreover, the flow may be kept active until all packets in the flow arrive at their destination to facilitate the end-to-end flow-based congestion control. In some examples, the flow extent (a parameter that tracks the amount of pending data within a flow) is set to a non-zero small value at the egress node of an upstream fabric to keep the flow active. At the ingress node of the downstream fabric, the flow extent is reset to its actual value to track pending data in the flow in the downstream fabric.

One aspect of the instant application provides a system and method for extending a flow channel from a first network fabric into a second network fabric. During operation, the system may identify, at an egress edge node of the first network fabric, a flow to which a received packet belongs based on a first flow identifier associated with the packet. The egress edge node may forward the received packet to the second network fabric, where a respective node in the second network fabric may identify the flow based on a second flow identifier. The system may indicate to an upstream node of the forwarded packet exiting the first network fabric and keep the flow active within the first network fabric after all packets in the flow exit the first network fabric and until all packets arrive at a destination node.

In a variation on this aspect, the first or second flow identifier corresponds to a hash value computed based on a plurality of header fields of the packet. The header fields may include one or more of a source address field, a destination address field, a traffic class field, an encapsulation header field, a job identifier field a Differentiated Service Code Point (DSCP) field, a User Datagram Protocol (UDP) port field, one or more Ultra Ethernet Consortium (UEC) Transport headers, a snoop number field, or any header fields that uniquely identify the flow in both the first and second network fabrics.

In a variation on this aspect, indicating to the upstream node of the forwarded packet exiting the first network fabric may include generating and sending an acknowledgment packet corresponding to the forwarded packet. The acknowledgment packet may specify an amount of acknowledged data.

In a further variation, the system may update a flow-extent value used for tracking pending packets in the flow within the first network fabric based on the acknowledgment packet.

In a further variation, keeping the flow active comprises withholding acknowledgment for at least a portion of an initial packet in the flow to ensure that the flow-extent value is non-zero.

In a further variation, the system may receive, from the destination node, acknowledgment for all packets in the flow, generate and send an acknowledgment packet associated with the portion of the initial packet in the flow, and terminate the flow within the first network fabric.

In a further variation, the system may set an injection limit at the ingress of a respective network fabric and perform flow-based congestion control in the respective network fabric, which may include pausing packet injection into the respective network fabric in response to a sum of flow-extent values of all active flows within the respective network fabric being greater than the injection limit.

In a further variation, the system may perform the flow-based congestion control further comprising receiving acknowledgements comprising downstream flow congestion information and using this information to separately control a maximum bandwidth of injected packets on each individual flow.

In a further variation, the system may reset the flow-extent value at an egress of the first network fabric. The reset flow-extent value tracks pending packets in the second network fabric.

In a further variation, the system may keep the flow active by setting a keep-channel-open flag field in the acknowledgment packet.

One aspect of the instant application provides a network edge node coupling a first network fabric and a second network fabric. The network edge node may include an ingress port to receive a packet from an upstream node within the first network fabric, a flow-channel identifying logic unit to identify a flow to which the received packet belongs based on a first flow identifier associated with the packet, and an egress port to forward the packet to the second network fabric. A respective node in the second network fabric may identify the flow based on a second flow identifier. The network edge node may further include an indicating logic unit to indicate to the upstream node of the forwarded packet exiting the first network fabric and a flow-maintaining logic unit to keep the flow active within the first network fabric after all packets in the flow exit the first network fabric and until all packets arrive at a destination node.

One aspect of the instant application provides a non-transitory machine-readable storage medium storing instructions executable by a processing resource to: identify, at an egress edge node of the first network fabric, a flow to which a received packet belongs based on a first flow identifier associated with the packet; forward, by the egress edge node, the received packet to the second network fabric, a respective node in the second network fabric to identify the flow based on a second flow identifier; indicate to an upstream node of the forwarded packet exiting the first network fabric; and keep the flow active within the first network fabric after all packets in the flow exit the first network fabric and until all packets arrive at a destination node.

In this disclosure, the functions include a plurality of logic units capable of performing predetermined logic function described throughout the disclosure. The functions shown in FIGS. 2 and 3 may be implemented using any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various functions described herein might be implemented as discrete circuits or the functions and features described can be shared in part or in total among one or more circuits. Even though various features or elements of functionality may be individually described or claimed as separate functions, these features and functionality can be shared among one or more common functions, and such description shall not require or imply that separate circuits are required to implement such features or functionality.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method for extending identification of a flow from a first network fabric into a second network fabric, the method comprising:
identifying, at an egress edge node of the first network fabric, a flow to which a received packet belongs based on a first flow identifier associated with the packet;
forwarding, by the egress edge node, the received packet to the second network fabric, a respective node in the second network fabric to identify the flow based on a second flow identifier;
indicating to an upstream node of the forwarded packet exiting the first network fabric; and
keeping the flow active within the first network fabric after all packets in the flow exit the first network fabric and until all packets arrive at a destination node.

2. The method of claim 1, wherein the first or second flow identifier corresponds to a hash value computed based on a plurality of header fields of the packet, and wherein the header fields comprise one or more of:
a source address field;
a destination address field;
a traffic class field;
an encapsulation header field;
a job identifier field;
a Differentiated Service Code Point (DSCP) field;
a User Datagram Protocol (UDP) port field;
one or more Ultra Ethernet Consortium (UEC) Transport headers;
a snoop number field; or
any header fields that uniquely identify the flow in both the first and second network fabrics.

3. The method of claim 1, wherein indicating to the upstream node of the forwarded packet exiting the first network fabric comprises generating and sending an acknowledgment packet corresponding to the forwarded packet, and wherein the acknowledgment packet specifies an amount of acknowledged data.

4. The method of claim 3, further comprising:
updating a flow-extent value used for tracking pending packets in the flow within the first network fabric based on the acknowledgment packet.

5. The method of claim 4, wherein keeping the flow active comprises withholding acknowledgment for at least a portion of an initial packet in the flow to ensure that the flow-extent value is non-zero.

6. The method of claim 5, further comprising:
receiving, from the destination node, acknowledgment for all packets in the flow;
generating and sending an acknowledgment packet associated with the portion of the initial packet in the flow; and
terminating the flow within the first network fabric.

7. The method of claim 4, further comprising:
setting an injection limit at the ingress of a respective network fabric; and
performing flow-based congestion control in the respective network fabric, which comprises pausing packet injection into the respective network fabric in response to a sum of flow-extent values of all active flows within the respective network fabric being greater than the injection limit.

8. The method of claim 7, wherein performing the flow-based congestion control further comprising receiving acknowledgements comprising downstream flow congestion information and using this information to separately control a maximum bandwidth of injected packets on each individual flow.

9. The method of claim 4, further comprising resetting the flow-extent value at an egress of the first network fabric, wherein the reset flow-extent value tracks pending packets in the second network fabric.

10. The method of claim 3, wherein keeping the flow active comprises setting a keep-channel-open flag field in the acknowledgment packet.

11. A network edge node coupling a first network fabric and a second network fabric, the network edge node comprising
an ingress port to receive a packet from an upstream node within the first network fabric;
a flow identification logic unit to identify a flow to which the received packet belongs based on a first flow identifier associated with the packet;
an egress port to forward the packet to the second network fabric, a respective node in the second network fabric to identify the flow based on a second flow identifier;
an indicating logic unit to indicate to the upstream node of the forwarded packet exiting the first network fabric; and
a flow-maintaining logic unit to keep the flow active within the first network fabric after all packets in the flow exit the first network fabric and until all packets arrive at a destination node.

12. The network edge node of claim 11, wherein the indicating logic unit comprises an acknowledgment-packet-generation logic to generate and send an acknowledgment packet corresponding to the forwarded packet, wherein the acknowledgment packet specifies an amount of acknowledged data.

13. The network edge node of claim 12, further comprising a flow-extent updating logic unit to update a flow-extent value used for tracking pending packets in the flow within the first network fabric based on the acknowledgment packet.

14. The network edge node of claim 13, wherein the flow-maintaining logic unit is to configure the acknowledgment-packet-generation logic to withhold acknowledgment for at least a portion of an initial packet in the flow to ensure that the flow-extent value is non-zero.

15. The network edge node of claim 14, further comprising a flow-termination logic unit to:
wherein the acknowledgment-packet-generation circuit is to generate and send an acknowledgment packet to acknowledge the portion of the initial packet in the flow in response to receiving, from the destination node, acknowledgment for all packets in the flow; and
wherein the flow-termination logic unit is to terminate the flow within the first network fabric in response to the acknowledgment of the portion of the initial packet.

16. The network edge node of claim 13, further comprising a flow-extent resetting logic to reset the flow-extent value at the egress port of the network node to track pending packets in the second fabric.

17. The network edge node of claim 12, wherein the flow-maintaining logic unit is to configure the acknowledgment-packet-generation logic to set a keep-channel-open flag field in the acknowledgment packet.

18. A non-transitory machine-readable storage medium storing instructions executable by a processing resource to:
identify, at an egress edge node of the first network fabric, a flow to which a received packet belongs based on a first flow identifier associated with the packet;
forward, by the egress edge node, the received packet to the second network fabric, a respective node in the second network fabric to identify the flow based on a second flow identifier;
indicate to an upstream node of the forwarded packet exiting the first network fabric; and
keep the flow active within the first network fabric after all packets in the flow exit the first network fabric and until all packets arrive at a destination node.

19. The non-transitory machine-readable storage medium of claim 18, wherein indicating to the upstream node of the forwarded packet exiting the first network fabric comprises:
generating and sending an acknowledgment packet corresponding to the forwarded packet, the acknowledgment packet specifying an amount of acknowledged data; and
updating a flow-extent value used for tracking pending packets in the flow within the first network fabric based on the acknowledgment packet.

20. The non-transitory machine-readable storage medium of claim 19, wherein keeping the flow active comprises withholding acknowledgment for at least a portion of an initial packet in the flow to ensure that the flow-extent value is non-zero.
